(19) United States
(12) Patent Application Publication
(10) Pub. No.: US 2009/0076926 A1
(43) Pub. Date: Mar. 19, 2009

(54) Method For Selling Multiple Like-Items In A Single Auction

(75) Inventors: David Zinberg, Bel-Air, CA (US); Leon Kuperman, Encino, CA (US)

Correspondence Address: SELDON & SCILLIERI, 12121 WILSHIRE BLVD., SUITE 1300, LOS ANGELES, CA, 90025-1166, US

(73) Assignee: David Zinberg, Culver City, CA (US)

(21) Appl. No.: 12/186,862

(22) Filed: Aug. 6, 2008

Related U.S. Application Data
(60) Provisional application No. 60/972,729, filed on Sep. 14, 2007.
(60) Provisional application No. 60/972,730, filed on Sep. 14, 2007.
(60) Provisional application No. 60/972,736, filed on Oct. 2, 2007.
(60) Provisional application No. 60/980,753, filed on Oct. 17, 2007.

(51) Int. Cl. G06Q 30/00

(52) U.S. Cl. 705/26

(57) ABSTRACT

An on-line auction method enables a seller to sell multiple like-items with a single auction by (a) offering an item for auction that is to be sold to the winning bidder at the end of the auction, (b) promptly communicating a post-auction offer to non-winning bidders and non-bidding viewers to purchase an additional quantity of like-items within a short first acceptance period following the auction, (c) upon the expiration of the first acceptance period, extending a second offer to non-winning bidders to purchase a like-item within a longer second acceptance period; and (d) extending a third offer to purchase an additional quantity of like-items to bidders and non-bidding viewers who have accepted a post-auction offer.

### FIELD OF THE INVENTION

This invention is directed to a system and method for selling products and/or services (hereinafter individually and collectively referred to as “items”) by on-line auction.

### BACKGROUND OF THE INVENTION

Conventionally, a seller having a plurality of an item creates a like plurality of auctions, with the winning bidder of each auction obtaining a respective one of the items. The need to set up and conduct multiple auctions is relatively time consuming, particularly since the auction must be conducted over a sufficiently long period to attract a desirable number of interested bidders.

One alternative has been the so-called “Dutch auction” wherein a seller offers a plurality of identical items for sale, and the winning bidders pay the amount of the lowest winning bid. For example, if the top three bids for three identical items are $25, $15, and $10, the three winning bidders pay $10.

In a variation of the basic Dutch auction, each bidder specifies the number of items sought and the price bid. Winning bidders pay a price equal to the lowest winning bid, with the winning bids being selected in order of bid price per item. For example, a bid for 5 of the items at $12 per item is ranked above a bid for 10 of the items at $11 per item. If there were 12 items available, and only these two bidders, the first bidder gets his/her 5 items at $11 each, and the second bidder gets the remaining 7 items at $11 each. In other words, the higher bidder gets his/her desired quantity at the lowest winning bid, while the lower bidder(s) get the remainder at the lowest winning bid. In Dutch auctions, the bidders know the number of available items, however, and there is a diminishing of the bidders' perceptions of scarcity of the item, thereby affecting desirability of the item and its perceived value.

In the foregoing variation of the Dutch auction, winning bidders may be given the right to refuse partial quantities. Bidders who win some, but not all, of the quantity bid for in such auctions do not have to buy any of them. This, of course, leaves the seller with the prospect of structuring another auction to deplete inventory. Further, sideline viewers are not drawn in, regardless of which variant of the Dutch auction is used.

A “Yankee” auction is a variation of the “Dutch” auction whereby successful bidders pay what they bid as opposed to paying the price determined by the lowest qualified bidder.

Multiple auctions, the Dutch auction (and its variations) and the Yankee auction all reduce the customer's perception of scarcity and, therefore, the perception of value, adversely affecting the seller's overall profit margin that might otherwise be obtained for said items.

### SUMMARY OF THE INVENTION

The invention herein is an on-line auction method and system that enables a seller to sell “like items” with a single auction, resulting in an increase in sale income from the item without the need to create and await a new auction or disclose the number of available for sale. (As used herein, the term “like item” is used to denote an item that is the same as an item, or so similar that a reasonable purchaser would accept it as an equivalent. Preferably “like items” are identical and are duplicates of the auctioned item.).

The method is implemented following the conclusion of an auction, and increases the sales of the “like items” without a need by the seller to create additional auctions and hope that the non-winning bidders (who have already expressed an interest in acquiring the item by their behavior) see the newly placed item and bid on it once again. Moreover, it attracts side-line viewers who are not necessarily engaged in the auction experience yet but are perhaps just watching to see how the process works. Such viewers may be intimidated by the auction format, and have decided not to jump into the auction until it is too late, or they may have other reasons for watching passively. The invention herein is designed to engage such viewers, and to also let them feel that they have won something despite having failed to place a bid.

Briefly, the invention herein is a multiple item auctioning system and method that comprises one or more of three components. The first component (hereinafter referred to as the “viewer's choice” component) provides non-winning bidders and non-bidders watching the auction (hereinafter, collectively, “viewers”) an opportunity after the close of the auction of an item to purchase one or more like items. In accordance with the invention, the total quantity of available like items is unknown to the bidders, retaining the perception of scarcity and value in the viewers' minds.

The “viewer's choice” quantity offered each viewer following the auction can be determined by the seller, but need not be disclosed. The quantity offered each viewer may be more than one, although “one” is the preferred quantity, and can be presented as an “all or nothing” offer if a quantity of more than one is to be offered; alternatively, the seller can offer each recipient of a “viewer's choice” offer an additional quantity “up to” a stated maximum quantity, and permit the offeree to determine the quantity accepted subject to that maximum. In the latter case, the maximum quantity is typically determined by either the number of like items remaining in the seller's inventory or by the number of like items that the seller believes can be offered to the offeree without diluting the perceived intrinsic value and desirability of the item. “Viewer's choice” offers are preferably sent to all eligible viewers, preferably on a “first come, first served” basis. If, for example, there are 100 viewers and only 10 like items, all 100 offers are made, and the first 10 customers that take action to accept the offer will be the recipients of the like items.

By making the post-auction offers, the seller is targeting people who have already shown an interest in the item. Accordingly, the post-auction offer is preferably made promptly following the close of the auction, before that interest has waned. Thus, the seller has a better chance of selling multiple like-items, and in much less time than a new auction would take. Moreover, while the profit to be derived from a new auction is unpredictable, the seller's gross profit margin when making the post-auction “viewer's choice” offer(s) is under the seller's control by virtue of the seller's control over the offered price. Those of ordinary skill in the art will recognize that the post-auction price can be equivalent to the winning bid, equivalent to the offeree's highest bid (if a bidder), or any other price that is acceptable to the seller. The pricing can be quantity-based, with the per-unit price decreasing as the quantity accepted by the offeree increases, to encourage the post-auction purchase of larger quantities, and the seller has the freedom to offer other incentives as well. Moreover, different viewers can be offered different pricing, depending on their status (e.g., bidder vs. non-bidder, early bidder vs. later bidder, etc.).

The second component (hereinafter referred to as the “Second Chance” component) generates a “second chance” offer to one or more of the non-winning bidders following the close of the acceptance period pertaining to the “viewer's choice” offer if certain criteria are met. By making a “second chance” offer directly to a non-winning bidder, who has already expressed an interest in the item, the seller has a better chance of selling unsold like items in much less time than a new auction would take. Preferably, the second chance offer is made promptly, before interest in the item has waned, and is subject to availability.

After the close of the auction on an item the third component (hereinafter referred to as the “More of Same” component) provides the winning bidder with an opportunity to purchase an additional quantity of like items. A “more of the same” offer can also be made to any viewer who accepts a post-auction “Viewer's Choice” offer, as well. The additional quantity offered following the auction is determined by the seller, but is preferably limited to 1 or 2 like items if available in inventory. If a quantity of more than one is offered, the offer may be presented as an “all or nothing” offer; preferably, however, the seller offers to sell the additional quantity “up to” a stated maximum quantity, and permits the offeree to determine the accepted quantity subject to that maximum and availability. In the latter alternative case, the maximum quantity is typically determined by either the number of like items remaining in the seller's inventory or by the number of like items that the seller believes can be offered to the offeree without diluting the perceived intrinsic value and desirability of the item.

By making the “more of the same” offer of an additional quantity to the winning bidder and to a viewer who has accepted a post-auction offer, the seller is targeting people who have already shown a serious interest in the item. Preferably, the “more of the same” offer is made during the check-out procedure following the close of the auction (or during the sales transaction following acceptance by a non-winning person of a “Viewer's Choice” offer). The seller accordingly has a better chance of selling multiple like-items, and in much less time than a new auction would take.

In accordance with the invention, a hierarchy is established among the three components for an integrated post-auction presentation that preferably seeks to maximize the seller's profit without detracting from the perceived value of the item. For example, the hierarchy may comprise the use of the “viewer's choice” component, then the “second chance” component and then the “more of same” component as follows:

(1) The “viewer's choice” component extends a “first come, first served” offer to all viewers to purchase an additional quantity of like items within a short period of time following the auction (preferably, for example, the first minute);

(2) Once the acceptance period of the “viewer's choice” offer has expired, the “second chance” component generates offers to the non-winning bidders, giving them a longer period in which to accept the offer and pay; e.g., several days.

(3) The “more of same” component generates offers to all viewers who accept an offer that has been generated by the “viewer's choice” and “second chance” components. The quantity offered by the “more of same” component preferably reserves enough inventory to fill each then-outstanding “viewer's choice” and “second chance” offer.

While the profit to be derived from a new auction is unpredictable, the seller's gross profit margin using the methods of a described herein is under the seller's control by virtue of the seller's control over the offered price, while (unlike other online auction formats such as the “Dutch” and “Yankee” formats) the quantity of available items remains unknown to the buyer(s).

Those of ordinary skill in the art will recognize that the post-auction offer can include quantity-based pricing instead of a fixed price per item to encourage the post-auction purchase of larger quantities.

These and further details of the invention will be apparent to those of ordinary skill in the art from reading a description of the preferred embodiment of the invention described below, and of which the drawings form a part.

### DESCRIPTION OF THE DRAWING

FIG. 1 is an illustration of a preferred pop-up window for communicating the “viewer's choice” offer to viewers of an on-line auction in accordance with the invention;

FIG. 2 is an illustration of a preferred pop-up window for communicating successful acceptance of a viewer's positive response to the “viewer's choice” offer;

FIG. 3 is an illustration of a preferred pop-up window for communicating a rejection of a viewer's positive response to the “viewer's choice” offer;

FIG. 4 illustrates a preferred pop-up window for conveying a “viewer's choice” offer that is directed to viewers who are not logged into the auction site;

FIG. 5 illustrates a preferred email offer conveying a “second chance” offer to non-winning bidders in accordance with the invention; and

### DESCRIPTION OF THE PREFERRED EMBODIMENT

“Viewer's Choice”

As described generally above, the invention herein comprises a method for selling items in an on-line auction format wherein additional like-items can be offered to bidders and non-bidding observers following the close of auction and without adversely affecting the perception of scarcity and value. First, as hereinafter referred to as the “viewer's choice” component, non-winning bidders and non-bidders watching the auction (hereinafter, collectively, “viewers”) are offered an opportunity after the close of the auction of an item to purchase an additional quantity of like-items. Preferably, each viewer is offered the opportunity to purchase one such item at a price equivalent to the winning bid, so long as there are sufficient like items in inventory following the auction. This is accordingly structured as a “first come, first served” offer without disclosing the number of like items available. The offer must preferably be accepted within a very short period of time; e.g., within one minute after the offer is made.

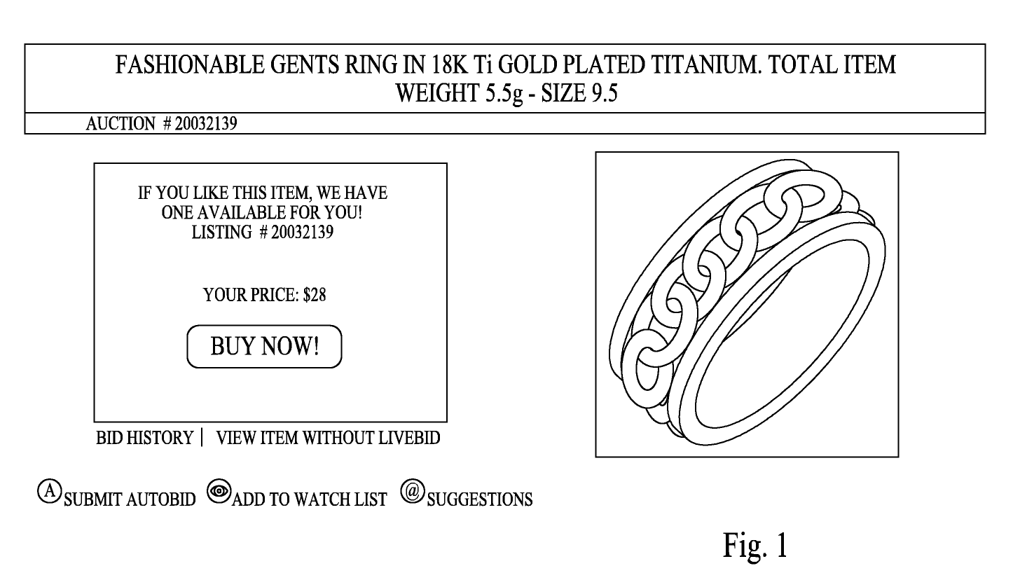

The “viewer's choice” offer is communicated electronically to the viewer promptly following the close of the auction, preferably via a pop-up window. FIG. 1 is an illustration of one such pop-up window that is directed to a viewer who is registered with, and has logged onto, the auction site (hereinafter, a “known viewer”). The pop-up conveys the fact that there may be a like item available to the viewer that can be purchased by clicking on the “buy now” button. Any pertinent terms and conditions, such as time limits for completing the transaction, can be included.

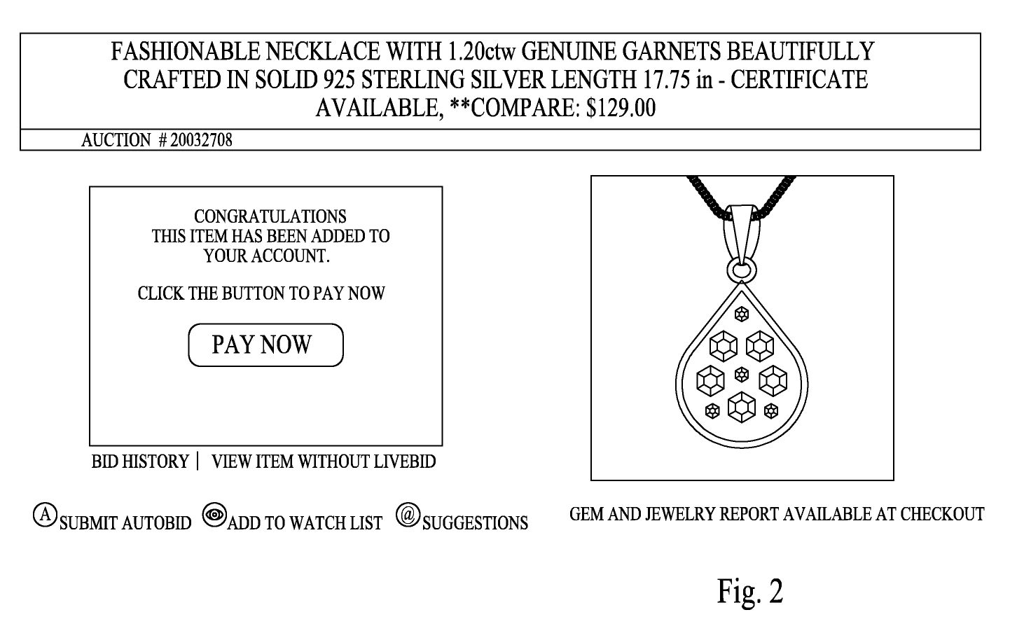

If the “buy now” button is clicked by a known viewer (e.g., a non-winning bidder who has previously registered for the auction) and there is an unreserved like item in inventory, the viewer has previously been qualified by the auction site and the transaction can proceed relatively automatically. Upon receiving the viewer's positive response to the offer by the clicking of the “buy now” button while like items remain in inventory, the auction system removes an item from its “available inventory” list, and reserves the item for the transaction with that viewer. The viewer is then presented with a second pop-up window (FIG. 2) stating that the item has been added to the viewer's account, and a “pay now” button is conveniently provided for the viewer to click. Upon clicking the “pay now” button, the known viewer is taken to the website's shopping cart page where the item has been placed in the viewer's cart, and the transaction is completed in the normal manner.

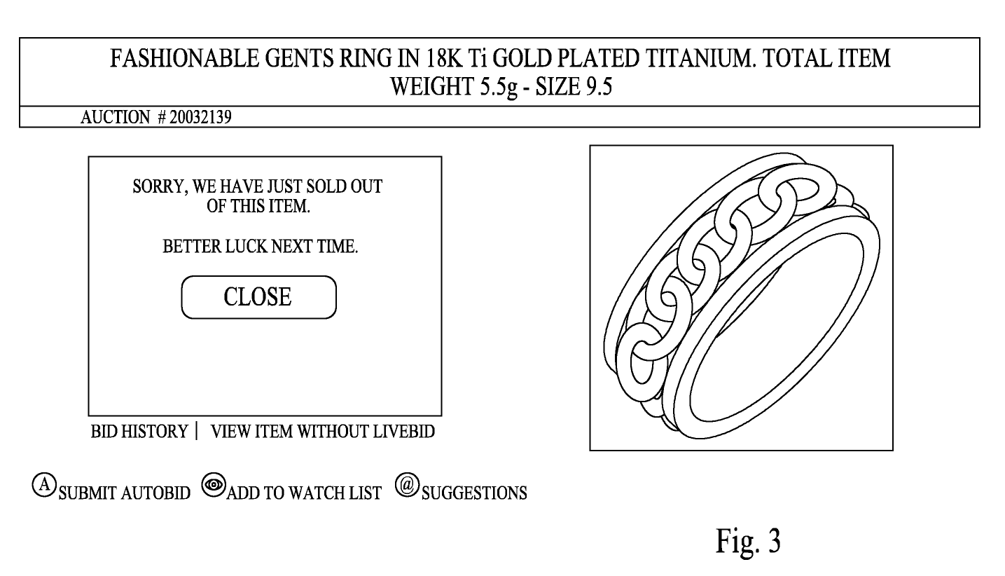

If, on the other hand, the logged-in viewer clicks the “buy now” button after “available inventory” of like-items has fallen to zero, the viewer gets a pop-up “rejection” window advising that the item is sold out. FIG. 3 is an illustration of a preferred pop-up window for communicating a rejection of a viewer's positive response to the “viewer's choice” offer, and can be diplomatically used for other reasons as well; e.g., where the auction site had had one or more prior negative experiences with the viewer.

The pop-up window making the “viewer's choice” offer (FIG. 1) preferably disappears if (1) the period of acceptance (e.g., one minute) has elapsed or (2) the viewer goes to a different web page (e.g., another auction at the seller's site, another website, etc.) Upon termination of the offering pop-up window, the item is preferably “placed” back into “available inventory”. All unsold items are placed back into “available inventory” upon expiration of the acceptance period.

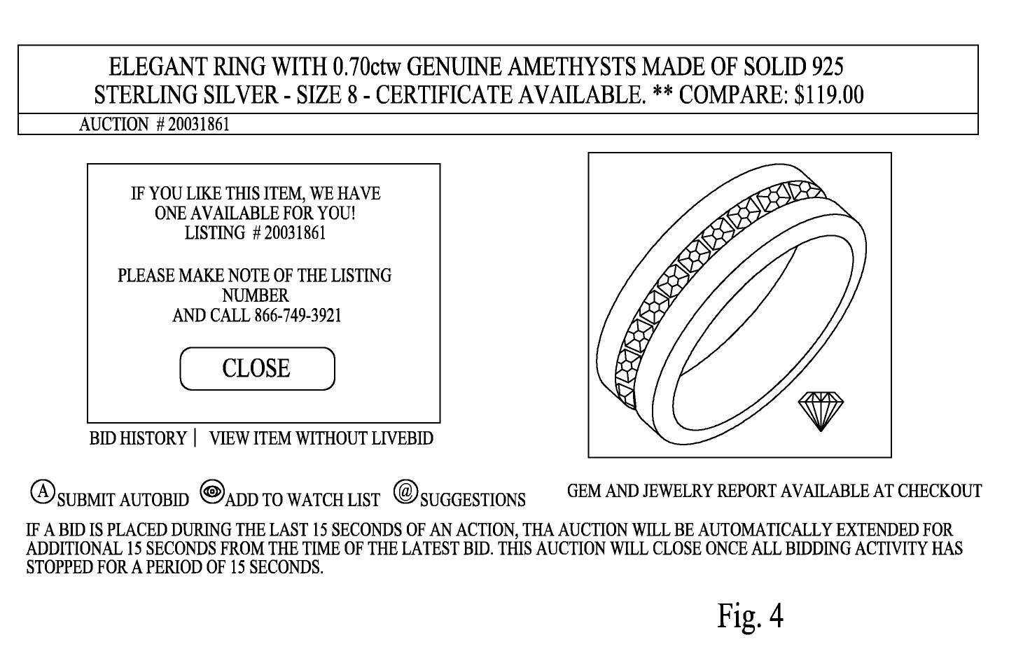

If a viewer receiving a “viewer's choice” offer is not logged onto the site, a pop-up window providing a telephone number instead of a “buy now” button is preferably used. FIG. 4 illustrates a pop-up window for conveying a “viewer's choice” offer that is directed to a viewer who is not logged into the site. Upon telephoning the number, the viewer can establish contact with a customer representative who will assist in the transaction, and/or in registering the viewer if desirable. During an appropriate portion of the transaction, the customer representative can delete the subject like-item from inventory, thereby reserving it for the viewer.

“Second Chance”

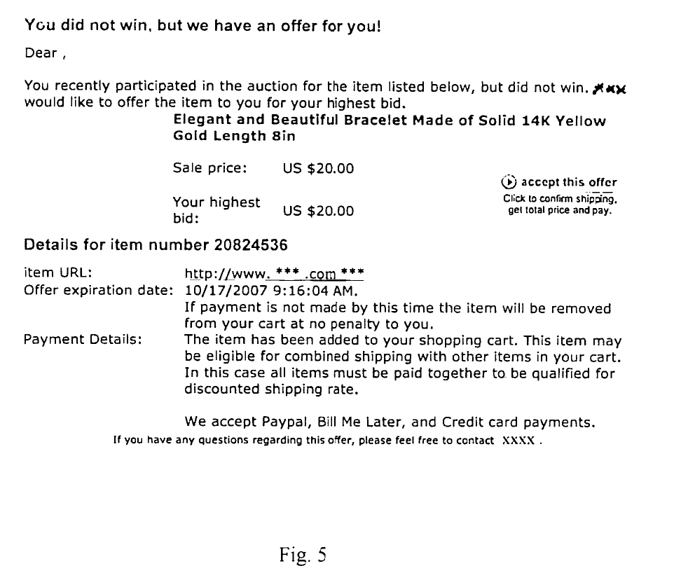

Immediately following the expiration of the “viewer's choice” acceptance period, “second chance” offers are made to one or more of the non-winning bidders if certain criteria (discussed below) are met. The “second chance offer” offers qualified non-winning bidders (as described below) the opportunity to purchase a like-item, and can be accepted within a relatively longer time period, preferably by paying for the item by a stated time and date that is 3-5 days following the auction. The “second chance” offer is preferably communicated by email to the non-winning bidders and is sent before interest in the item has waned. FIG. 5 illustrates a preferred email that communicates the offer. A number of like items equivalent to the number of outgoing “second chance” offers is preferably removed from “available inventory”, thereby reserving the items for the potential transactions. Alternatively, the emailed offer can also made subject to availability of the item; i.e., “first come, first served”.

One of the above-mentioned criteria relates to the price. Generally, the price stated in the emailed offer is equivalent to the bidder's highest bid. If the bidder's highest bid is not satisfactory to the seller, however, there are two possibilities. The first is to refrain from making the second chance offer to that viewer, and to restrict the emailed offers to those non-winning bidders whose highest bids were equal to or above the seller's minimally acceptable price. The price offered is preferably equal to the non-winning bidder's highest bid; this is the preferred strategy since the viewer has already indicated that (s)he would pay this amount but not more. The second possibility is to send the second chance offers to all non-winning bidders so long as there is available inventory, but to set a different price that is more than the lowest acceptable price; however, prices lower than the last-bid price cheapen product perception and can adversely affect profit.

The second of the above-mentioned criterion relates to the number of like items in inventory. Preferably, the number of emailed “second chance” offers does not exceed the number of available like-items in inventory. If the number of acceptable non-winning bidders exceeds the number of available items, the outgoing offers are preferably restricted to the top-bidding non-winning bidders in “top down” order until the number of extended offers equals the number of items available in inventory; e.g., if there were five non-winning bidders whose highest bids were above the seller's acceptable minimum price, but only three like-items available in inventory, the “second chance” offer would only be emailed to three highest bidding non-winning bidders.

“Second chance” offers can also (as a term of the offer) be made subject to unilateral revocation by the seller, enabling the seller to generally simultaneously offer the like-item(s) to a greater number of non-winning bidders without waiting for the offer period to expire. This latter feature enables the seller to minimize the risk of being left with the item won by the highest bidder if the winning bidder refuses or fails to pay within the period set by the auction's rules, as well well as maximizing the seller's opportunity to efficiently minimize the inventory of like-items. By offering the won item to an additional offeree, the seller can thereby create, if desirable, a potential back-up transaction that can be unilaterally negated upon payment by the winning bidder.

The second chance offers are preferably added to the non-winning bidders' accounts and shopping carts automatically so they can each easily accept the offer by selecting it at checkout.

Preferably, “second chance” offers should not be made to the winning bidder when the “second chance” price is less than the winning bid, and should not be made to viewers who have accepted a “viewer's choice” offer where the “second chance” price is less than the “viewer's choice” price. Since the “viewer's choice” price is preferably the same as the winning bid, no winning bidder or accepting “viewer's choice” offeree will receive a “second chance” offer.

“More of Same”

The “more of same” component makes a post-auction offer of additional like-items to the winning bidder and to those “viewer's choice” and “second chance” viewers who respond positively to the post-auction offers if there are like-items in “available inventory” that can fill the “more of same” request.

In operation, the auction website's system software is programmed to automatically make the post-auction “more of same” offer at the check-out window in accordance with rules set by the seller. Although the offer could offer as many like items as allowed by the remaining items in inventory, it is preferable to only offer 1-2 such additional items to retain the perception of value. In addition, it is preferred to retain the same unit price for the “more of same” items as is being paid for the initially accepted item, although the price can be calculated by the system in accordance with any formula or criterion desired by the seller.

The offer can, by its stated terms, expire at any time set by the seller. It can be the same as the expiration of time for paying for the first item, which is the currently preferred choice, or it can be different.

Many variations in the methodology are possible without departing from the scope of the invention. For example, all the post-auction offers can (as a term of the offer) be made subject to unilateral revocation by the seller, enabling the seller to offer the like-item(s) to others without waiting for the offer period to expire. This latter feature encourages the offeree to act promptly and permits the seller to maximize the number of post-auction offers made, thereby minimizing the seller's risk of being left with the unsold like items (as well as an unsold auctioned item if the winning bidder refuses or fails to pay within the period set by the auction's rules).

The auction site can provide a field on its the shopping cart page that permits the winning bidder (and other offerees, if any) to select the desired quantity of like items at the price(s) stated by the seller. The system software can simplify an offeree's acceptance of the post-auction offer by permitting the offeree to select the quantity desired from a drop-down menu at his/her shopping cart page.

The system software can also be configured to prevent post-auction offers from being made to persons who have previously acted dishonestly or unethically at the auction site, and to persons with whom the site has experienced excessive non-paid items during a recent (predetermined or seller-defined) period.

The on-line auction method described above accordingly permits bidders at the auction site to efficiently obtain items from a seller, in quantity, at a price set by the market (e.g., the winning bid) and acceptable to the offeree. At the same time, the process permits a seller to efficiently minimize inventory at a gross margin that is both predicable and acceptable to the seller, while maintaining the perception of scarcity and value.

An example of the preferred methodology is now illustrated by way of example. Assume an item for which there are 10 items in inventory. Assume further that there is a winning bid of $50, that four other non-winning bidders had respective highest bids of $48, $46, $45 and $44 (all of which are above the seller's minimally acceptable price). In addition, five logged-in viewers were just watching the auction. As the on-line auction progressed, a record of the “auction history” was maintained by the auction website, documenting the identity of each bidder and each logged-in non-participating viewer, as well as each bidder's bids. Alternatively, the auction history can document more limited information: e.g., the identity of each bidder, the bidder's highest bid, and the identities of the non-participants viewing a predetermined end portion of the auction.

Bidder no. 1 wins, goes to the check-out page, and is offered a “more of same” opportunity to purchase a second such item for an additional $50. “Available inventory” is reduced to “8”. If the winning bidder rejects the “more of same” offer, available inventory is incremented by 1. If he decides not to pay for the won item, it is incremented by “2”. Assume the winning bidder takes only the item he won. There are accordingly 9 items in “available inventory”.

In the meantime, pop-up windows have appeared on the screens of the four non-winning bidders and the five non-bidding viewers, conveying the “viewer's choice” offer to sell the same item for $50 to each of them. “Available inventory” is accordingly reduced by 9; if, however, there are less than 9 like items in inventory, “viewer's choice” offers only go out to non-winning bidders in “top down” order, and then to as many of the non-bidding viewers as can be addressed with the remaining inventory. If two of the offerees respond positively within the one minute acceptance period, the remaining 7 items are “placed” back in inventory. Each of the two accepting offerees receives a “more of same” offer of one additional item at $50. Assume that one non-winning bidder and one non-participating viewer accept the “viewer's choice” offer, and that one accepts the “more of same” offer.

Of the original ten items, six now remain in inventory: one went to the winner, and two went to non-winning viewers. Accordingly, six “second chance” offers could be sent out, but there are only four non-winning bidders, of whom one accepted a “viewer's choice” offer. Preferably, three “second chance” offers are emailed to those non-winning bidders who did not accept a “viewer's choice” offer. Generally, it is preferable to refrain from sending a “second chance” offer to the winning bidder and to individuals who have already accepted a “viewer's choice” offer. Assuming the non-winning bidder with the $48 highest bid accepted the “viewer's choice” offer, the email offers the remaining non-winning bidders a like item for their respective highest bids of $46, $45 and $44. Each non-winning bidder who accepts a “second chance” offer is then offered a “more of same” offer at the same unit price as his/her “second chance” price.

The result of the foregoing methodology is that the seller has sold multiple items through a single auction at mutually acceptable prices without disclosing the number it items actually available.

The bidders cannot rely on additional items being available, even if they know there may be some, and cannot tell how many will be available if there are, in fact, additional items. It accordingly behooves them to win the auction or at least keep the bidding going in an effort to be at least the second or third highest bidder in a risky attempt to receive a possible “second chance offer”. The seller gains by being able to target clearly interested individuals without the delay necessitated in setting up and conducting a subsequent auction. The offerees gain by being able to acquire the item at a price at or near what they were willing to pay a short time before.

Moreover, the use of “second chance” offers in accordance with the invention is not likely to substantially affect the dynamics of the auction. The only certain way to acquire the item remains a submission of the winning bid. Even if aware of the possibility of a “second chance” offer, bidders do not know if there are more than one of the auctioned item, and do not know how many “second chance” offerees (if any) will have the opportunity to purchase the item after the auction. In addition, bidders are unaware of the seller's cost, the seller's required gross margin and/or the quantity available; accordingly, they cannot predict where the cut-off for a “second chance” offer would be. Thus, the only certain way to acquire the item remains a submission of the winning bid. In accordance with the invention, the seller's desired gross profit margin for the offered items can be maintained if the seller has one or more duplicate items for sale.

### Auction System Considerations

In operation, winning and non-winning bidders have registered with the website, and their identities are accordingly known from the information provided during the registration process. Other viewers will need to register if they wish to take advantage of a post-auction offer made to them.

The bidders place their bid(s) on an item until the action closes. The auction site's system software can then be utilized to download a sales report, place the auctioned item into the auction winner's shopping cart, and then immediately activate the “viewer's choice” pop-up window offer for communication to the non-winning bidders and non-participating viewers who have logged in. The offered price and quantity is either set within the system (e.g., one like-item at a price equal to the winning bid) or calculated in accordance with one of several algorithm that can be chosen by the seller.

Preferably, the auction website's system software is further programmed to automatically make as many second-chance offers (in accordance with the pricing algorithm desired by the seller) as allowed by the number of items remaining in inventory and the rules set by the seller, once the acceptance period for the “viewer's choice” offer has expired. The seller's rules, for example, can permit offers to be made to non-winning bidders at a price equivalent to that bidder's highest bid if that “second chance” price is equal to or exceeds the seller's minimum acceptable gross profit margin. Alternatively, the “second chance” offer can be made at a price chosen by the seller. Alternatively, the “second chance” offer made to each recipient can be the greater (or lesser) of those two amounts. Any of these choices, or any other choice, can be encoded into the auction software as a seller's choice.

Where the seller simply wishes to exhaust inventory, a “second-chance” offer at a price determined by the seller can, for example, be extended to all non-winning bidders until the list of non-winning bidders is exhausted, and then (in accordance with seller-determined prices) to logged-in, non-participating viewers until all available items have been offered. In summary, the price to each recipient can be calculated in accordance with any formula desired by the seller, or can be a predetermined price.

The item that is the subject of the “second chance” offer is preferably placed into the recipient's shopping cart to make the ensuing transaction extremely convenient for the recipient if accepted, and can also appear in his or her “Payment” web page, if such a page is used by the auction website. The placement of the item in the recipient's shopping cart is described to them in the emailed offer, and the ease of the transaction is preferably referred to. The item is automatically removed form the viewer's shopping cart after the time specified for acceptance.

The second-chance offer subroutine accordingly reads all of the second-chance offer settings (e.g., desired gross profit, winning and highest losing bids for each bidder) and determines whether a second-chance offer can be extended to one, several or each non-winning bidder of the then-closed auction. If one or more second-chance offer can be extended, the system preferably performs the following actions:

a. It places the second-chance item into the non-winning bidder's shopping cart so that the item appears in the shopping cart where it is viewed by the non-winning bidder;

b. It notifies the non-winning bidder about the second-chance offer's terms and conditions via email with an explanation of the second chance offer, a description of the item and the expiration time/date for the offer;

c. It decrements the quantity representing available inventory to hold the item for that particular non-winning bidder for the time that the offer is extended to that non-winning bidder; and

d. It preferably creates a record for auditing purposes with the then-current “second-chance” offer settings and item information.

The non-winning bidder can then access his/her shopping cart and pay for the second-chance offer item before the expiration time/date. A detailed report can then be generated by the controlling software, if desired, containing such information as:

Information related to second-chance offer settings:
Margin in percent (%)
Margin absolute ($)
Number of the same SKU items available from inventory at the time of the second-chance offer
Number of top unique non-winning bidders for the item
Price type settings—a bidder's price or winner's price

Information related to sales
Total number of second-chance offers extended
Total number of second-chance offers accepted
Cost
Sales
Margin in $
Margin %
Average cost per item

The system software can also be configured to prevent post-auction offers from being made to persons who have previously acted dishonestly or unethically at the auction site, and to persons with whom the site has experienced excessive non-paid items during a recent (predetermined or seller-defined) period.

The auction site's system preferably present a pop-up window to the viewer following the close of the auction, or send the viewer email containing the offer and a linked target and/or telephone number to call if interested in purchasing the item. Other communication techniques can be used to get the viewer's attention and transmit information concerning the availability of the post-auction transaction without departing from the scope of the invention.

The aforedescribed pop-up windows (and/or linked destination pages in the emailed offers) can include an anthem (or other music) with fireworks (or other visually attractive graphics) to make the announcement in an exciting manner. The pop-up windows (or linked destination pages) can state the terms and conditions of the post-auction offer, including an acceptance deadline.

A visible timer in the form of a clock or decrementing digital readout (e.g., 00:60 to 00:59, etc.) can be displayed to motivate the recipient to act in a timely manner.

Generally, it is preferable to offer remaining items to the non-winning bidders (from highest final bid to lowest final bid), followed by offers to the non-bidding viewers. Bidding viewers may be seen to have a higher level of interest in the item than those who merely watch the auction without bidding. However, it may be desirable to make post-auction offers to all viewers, with a reserved right in the seller to unilaterally terminate the offer, so that the increased number of post-auction offers increases the seller's chances for maximizing the number of items that can be sold in this manner while permitting the seller to then terminate the remaining non-accepted post-auction offers.

Naturally, there are a numerous modifications that a seller can make to foregoing structure without falling outside the scope of the invention. The foregoing description is merely illustrative of the principles of the present invention and is not to be construed in a limiting sense. Various changes and modifications will become apparent to those of ordinary skill in the art. All such changes and modifications are seen to fall within the scope of the invention as defined by the appended claims.

We claim:

1. An on-line auction method that enables a seller to sell multiple like-items with a single auction comprising the steps of:
(a) offering an item for auction that is to be sold to the winning bidder at the end of the auction;
(b) promptly communicating a post-auction offer to non-winning bidders and non-bidding viewers to purchase an additional quantity of like-items within a short first acceptance period following the auction;
(c) upon the expiration of the first acceptance period, extending a second offer to non-winning bidders to purchase a like-item within a longer second acceptance period; and
(d) extending a third offer to purchase an additional quantity of like-items to bidders and non-bidding viewers who have accepted a post-auction offer offers.

2. The method of claim 1 wherein the post-auction offer of step (b) is a “first come, first served” offer.

3. The method of claim 1 wherein the post-auction offer of step (b) is communicated to all non-winning bidders and non-bidding viewers.

4. The method of claim 1 wherein the number of post-auction offers of step (b) is promptly communicated following the close of the auction to the non-winning bidders in top-down order, and then to non-bidding viewers, until the number of communicated offers is approximately equal to the number of non-purchased like-items in inventory.

5. The method of claim 1 wherein the first acceptance period is approximately one minute from the receipt of the offer.

6. The method of claim 1 wherein the first offer is communicated electronically to the recipient of the offer via a pop-up window that appears on the recipient's monitor.

7. The method of claim 6 wherein the pop-up window includes an acceptance image that can be clicked by the recipient to accept the offer.

8. The method of claim 7 wherein the recipient's clicking of the acceptance image causes the accepted quantity of the like-item to be deleted by the on-line auction system from a stored list of available inventory so that the accepted quantity is effectively reserved for the accepting recipient pending completion of the transaction.

9. The method of claim 7 wherein, upon receiving the recipient's acceptance of the offer via the clicking of the acceptance image while like-items remain in inventory, the auction system removes the accepted quantity of like-items from an “available inventory” category to effectively reserve the accepted quantity item for the transaction with that recipient.

10. The method of claim 8 wherein the recipient is presented with a second pop-up window following the clicking of the acceptance image, acknowledging receipt of the acceptance and providing payment instructions.

11. The method of claim 10 wherein the payment instructions include a payment image which, when clicked by the recipient, sends the recipient to a web page for completing the transaction.

12. The method of claim 8 wherein the like-item is placed back into the inventory list upon the earlier of expiration of the first acceptance period and the recipient's moving to another web page.

13. The method of claim 7 wherein the recipient is provided with a pop-up “rejection” window advising that the item is sold out when the recipient clicks the image after all available like-items in inventory have been accepted.

14. The method of claim 6 wherein the pop-up window is removed from the recipient's monitor upon the earlier of the first acceptance period elapsing and the recipient going to a different web page.

15. The method of claim 6 wherein the pop-up window includes a telephone number for establishing contact with a customer representative of the auction to accept the offer and complete the transaction.

16. The method of claim 1 wherein the second acceptance period is in excess of approximately 8 hours.

17. The method of claim 1 wherein following the close of the first acceptance period auction, the number of second offers of step (c) is promptly communicated to the non-winning bidders in top-down order until the number of communicated offers is approximately equal to the number of non-purchased like-items in inventory.

18. The method of claim 1 wherein the second offers of step (c) are communicated to the recipients by email.

19. The method of claim 1 wherein a number of like-items equivalent to the number of outgoing second offers is removed by the auction system from its inventory list of available like-items to effectively reserving the items for the potential transactions.

20. The method of claim 1 wherein the second offer is made subject to availability of the item.

21. The method of claim 1 wherein the second offer offers the like-item at a price approximately equivalent to the recipient's highest bid.

22. The method of claim 1 wherein the second offer is restricted to non-winning bidders whose highest bids were equal to or above the seller's minimally acceptable price.

23. The method of claim 1 wherein the number of second offers does not exceed the number of available like-items in inventory.

24. The method of claim 23 wherein the outgoing second offers are restricted to the top-bidding non-winning bidders in “top down” order until the number of outgoing offers equals the number of items available in inventory.

25. The method of claim 1 wherein the second offers are subject to unilateral revocation by the seller.

26. The method of claim 1 wherein the auction website's system software is programmed to automatically make the third offer during the payment process following acceptance of prior offer.

27. The method of claim 1 wherein the number of like-items in inventory is not disclosed to the offeree.

28. The method of claim 27 wherein the item is auctioned at a webpage that does not recite the availability of a like-item.

29. An on-line auction method that enables a seller to sell multiple like-items with a single auction comprising the steps of:
(a) offering an item for auction that is to be sold to the winning bidder at the end of the auction that is presented on a web page;
(b) forwarding an offer of at least one like item following the close of the auction to non-winning bidders and non-bidders without disclosure of the number of available like-items, said offer including an acceptance period having a duration of the lesser of (a) less than approximately three minutes and (b) the recipient's movement to a new web page.

30. The method of claim 29 wherein the offers are “first come, first served”.

31. The method of claim 29 wherein the offers are made subject to exhaustion of inventory.

32. The method of claim 29 wherein the number of offers forwarded is approximately equivalent of the number of like-items in inventory.
